(19) United States
(12) Patent Application Publication
(10) Pub. No.: US 2009/0061832 A1
(43) Pub. Date: Mar. 5, 2009

(54) System and method for wireless call parking

(75) Inventors: James E. Goggans, Olathe, KS (US); Michael K. Bugenhagen, Olathe, KS (US)

Correspondence Address: IP Department;Sonnenschein Nath & Rosenthal LLP, P.O. Box 061080, Wacker Drive Station, Chicago, IL, 60606, US

(73) Assignee: Embarq Holdings Company, LLC

(21) Appl. No.: 11/897,412

(22) Filed: Aug. 29, 2007

(51) Int. Cl. H04Q 7/38

(52) U.S. Cl. 455/414.1

(57) ABSTRACT

A system and method for parking an incoming call. User input is received on a wireless device to park the incoming call. The incoming call is parked. An announcement is played to the caller. The incoming call is connected to facilitate a communication between a user and the caller in response to receiving user input to release the incoming call.

### BACKGROUND

The use of and development of communications has grown nearly exponentially in recent years. The growth is fueled by larger networks with more reliable protocols and better communications hardware available to both service providers and consumers. Users have similarly grown to expect better communications from home, work, and on the go. Many users often use communications devices, such as cellular telephones, for business as well as personal use. As a result, many individuals carry a wireless device with them at all times. The use of and communications using wireless devices are not appropriate in all circumstances. In many cases, it is considered rude or inappropriate to answer an incoming call. The level of acceptable wireless usage depends on the environment and company or bystanders, if any. For example, a ringing phone or answering a phone call during a seminar or in a movie theater is considered very impolite.

In many cases, an incoming call may be very important or even crucial to the wireless user. For example, information regarding a medical emergency in the family is necessarily or best delivered person-to-person rather than using other options, such as voicemail. Using a wireless device set to vibrate is not always an effective way to balance wireless concerns because of the required proximity to the phone to feel the vibration and the time required for the user to move to an appropriate location to answer the phone and carry on a conversation. As a result, it is not uncommon to miss a call for purposes of etiquette or to not disturb others with a ring and/or voice conversation even if the call is perceived as important.

### SUMMARY

One embodiment provides a method for parking an incoming call. User input is received on a wireless device to park the incoming call. The incoming call is parked. An announcement is played to the caller. The incoming call is connected to facilitate a communication between a user and the caller in response to receiving user input to release the incoming call.

Another embodiment includes a wireless call park system. The system may include a processor for executing a set of instructions. The system may also include a memory for storing the set of instructions. The set of instructions are configured to receive user input on a wireless device to park the incoming call, park the incoming call, and connect the incoming call to facilitate a communication between a user and a caller in response to receiving user input to release the incoming call.

Yet, another embodiment provides a wireless device for call parking. The device may include call park logic configured to receive user input to park an incoming call, park the incoming call, and connect the incoming call to facilitate a communication between a user and a caller in response to receiving user input to release the incoming call. A memory in communication with the call park logic configured to play a stored message to the caller when the incoming call is parked based on the user input.

### BRIEF DESCRIPTION OF THE DRAWINGS

Illustrative embodiments of the present invention are described in detail below with reference to the attached drawing figures, which are incorporated by reference herein and wherein:

FIG. 1 is a pictorial representation of a wireless environment in accordance with an illustrative embodiment;

FIG. 2 is a wireless device in accordance with an illustrative embodiment;

FIG. 3 is a block diagram of a wireless device in accordance with an illustrative embodiment;

FIG. 4 is a flowchart of a process for receiving user input for parking a wireless call in accordance with an illustrative embodiment;

FIG. 5 is a flowchart of a process for parking a wireless call in accordance with an illustrative embodiment;

FIG. 6 is a flowchart of a process for parking a wireless call in accordance with an illustrative embodiment; and

FIG. 7 is an interface of a wireless device in accordance with an illustrative embodiment.

### DETAILED DESCRIPTION OF THE DRAWINGS

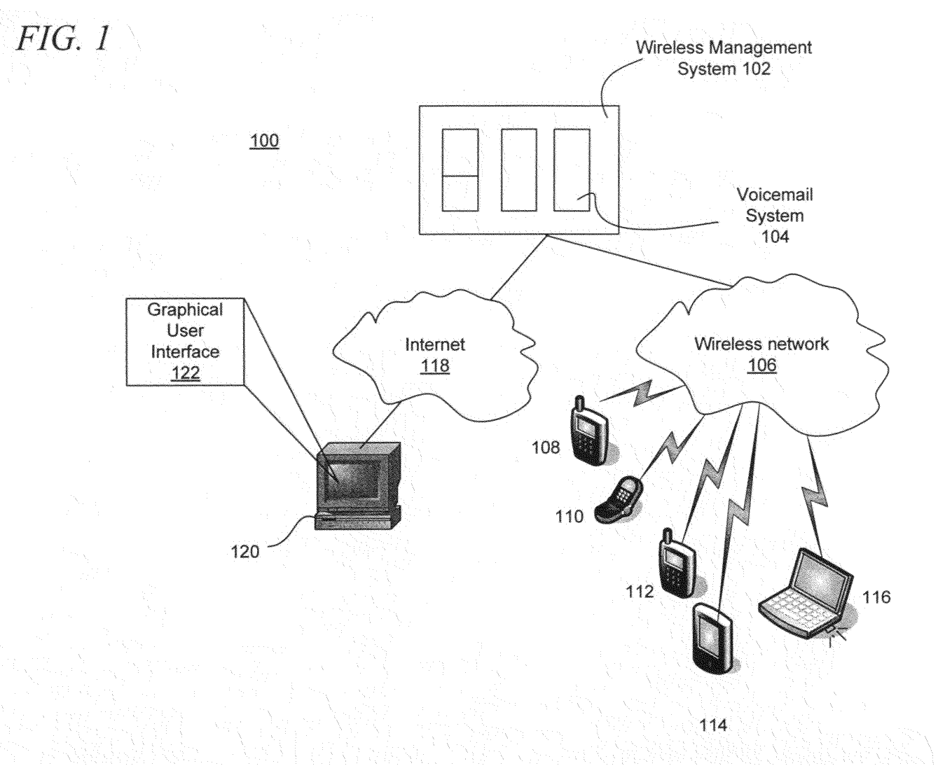

FIG. 1 is a pictorial representation of a wireless environment in accordance with an illustrative embodiment. The wireless environment 100 of FIG. 1 may include various components including a wireless management system 102, a voicemail system 104, a wireless network 106, wireless devices 108, 110, 112, 114, and 116, Internet 118, a client 120, and a graphical user interface (GUI) 122.

The wireless management system 102 may be a combination of hardware and software for managing the wireless network 106. The wireless management system 102 may be or include any number of intelligent network devices, servers, and components. For example, the wireless management system 102 may be an advanced intelligent network device that may quickly and economically modify the billing configuration and preferences of the voicemail system 104. The wireless management system 102 and the wireless network 106 may include any number of devices including mobile switching centers (MSC), exchanges, databases, home locator records, virtual locator records, adapters, wireless transceivers, servers, switches, routers, and other similar devices, connections, and components.

The voicemail system 104, a MSC individual wireless devices 108, 110, 112, 114, and 116, or a separate announcement and call park system may be used to implement wireless call parking. A call that is received through a land line, voice over Internet Protocol (VoIP) telephone, wireless device, or other telephone device may be routed through the wireless management system and wireless network 106 to the specified wireless device. The user of the wireless device, such as wireless device 108, may provide user input to temporarily park the call and play an announcement or message to the caller indicating the caller is temporarily parked.

As used herein, parking a call or a parked call refers to temporarily suspending call processing that leads to a normal voice conversation. Parking may include, but is not limited to placing the call on hold, using a temporary voicemail connection, connecting the phone with mute activated so that the caller cannot hear an incoming sounds, connecting to an audio message on the wireless device, connecting to a media player on the wireless network designated for call parking, or any other system and method suitable for suspending the call. The call may be parked so that the user may take the wireless device 108 to a better location, ensure privacy, or otherwise prepare to answer the incoming call and carry on a conversation. In some embodiments, call parking may be performed entirely by network devices or resources, such as a voicemail server, media player, or other intelligent network device. In other embodiments, call parking is performed by the wireless device in order to preserve network resources for other communications.

In the event, the user is unable to take the parked call, the user may provide another input through the wireless device 108 to play a message, end the call, send the incoming call to the voicemail system 104, or transfer the call to another telephonic device. The parked call may be automatically transferred to voicemail if the user does not connect or respond to the call within a specified time period. For example, a message indicating the user is unable to answer the call even after call parking may be played and the call transferred to voicemail.

In one embodiment, the user may employ the client 120 to review and update information and preferences stored in the wireless management system, voicemail system 104 or wireless device 108 that enable the mobile device to have a call park with announcement features. In one embodiment, the voicemail system 104 or wireless management system 102 may include a specialized software module for parking an incoming call that facilitates playing a parked call announcement, a message indicating when the call is being transferred to voicemail, and otherwise processing the call.

The voicemail system 104 may also control invoicing, billing, payment and record keeping of services provided through the wireless network 106. In one embodiment, the wireless call park platform or voicemail system 104 may be an integrated software module within the wireless management system 102. In another embodiment, the voicemail system 104 may be a storage database, independent platform, wireless call park application device or server linked with the wireless management system 102. Alternatively, the voicemail system 104 may be externally linked with the wireless management system 102 or integrated with the wireless devices 108, 110, 112, 114, and 116. For the purposes of describing the illustrative embodiments and corresponding systems, the term voicemail will be used to describe the wireless call park feature implemented by a platform, application, media player, or other device whereby a user may store preferences for implementing and personalizing the wireless call park feature.

The wireless management system 102 may perform administrative and automatic changes and configurations for the wireless network 106 by acting as a gateway, proxy, interface or control system. The wireless network 106 broadcasts wireless signals to the wireless devices 108, 110, 112, 114, and 116. The wireless devices 108, 110, 112, 114, and 116 may be any number of wireless devices including cellular phones, a Blackberry®, personal digital assistants (PDA), laptops, and other wireless communications or telephonic devices suitable for voice communications.

The wireless network 106 may use any number of wireless communication protocols including, but not limited to, code division multiple access (CDMA), time division multiple access (TDMA), global system for mobile (GSM) communications, WiFi, and WiMAX. The wireless management system 102 may communicate signals, data, and information with other wireless networks, publicly switched networks, data networks, such as the Internet 118, and other public and private communications networks.

The Internet 118 may be any type of data or communication network connecting the wireless management system 102 and the client 120 using a fiber optic connection, T1, cable, DSL, satellite, high-speed trunk, or other wired or wireless connections. Aspects of different embodiments may be performed by the wireless management system 102, the voicemail system 104, or the wireless devices 108, 110, 112, 114, and 116 based on communications with other data and/or communications systems.

Any number of communications protocols may be used to exchange data between the client 120 and the wireless management system 102. In one embodiment, the communications protocol is a common channel signaling system 7 (SS7). SS7 refers to the exchange of information between communications components required to provide and maintain service. The SS7 protocol is used by broadband networks to establish connections between switches and other devices in order to perform call-establishment, billing, routing, and information-exchange functions of the wireless network 106. The communications protocol may also be based on transmission control protocol (TCP) and Internet protocol (IP) standards or other commonly used communications protocols.

The client 120 may be a computing device suitable for displaying the GUI 122 to the user. For example, the client 120 may be a personal computer and the GUI 122 may be integrated or accessible from an application, such as a web browser. In another embodiment, the GUI 122 may be a secure client executed by a data processing system to perform the features and tasks described herein. Alternatively, the GUI 122 may be part of a website provided by the wireless management system 102 to allow the user to set call park preferences, set time-out time periods, select or record messages and music, and view parked call activity.

The wireless management system 102 may include a host application for managing communication with one or more remote clients. A user may be required to provide a secure identifier, such as a user name, password, or other authentication code or hardware interface that verifies the user is authorized to make changes within the voicemail system before the client 120 is granted access to all or a portion of the voicemail system 104. The authentication information may be used to establish a secure connection between the client 120 and the wireless management system 102. The secure connection may be a virtual private network tunnel, an encrypted connection, firewall, or other form of secured communications link.

The GUI 122 may be configured to both display and receive information from the user. The user may include any number of fields, buttons, icons, and other interfacing elements for display content and receiving user input and selections. In particular, the GUI 122 may display whether the user has purchased or otherwise enabled a call park feature. For example, the GUI 122 may display messages that the user may play to a caller once while parking the call. The GUI 122 may also specify a maximum time period that a caller may be parked before the call is terminated, sent to voicemail, rings through again, or is transferred to another telephonic device. For example, once a user selects to park a call, the user may be required to answer the call within a minute or the call is automatically connected to the voicemail system 104 so that the caller may leave a message. The user may also select a favorite song, newscast, or other information to be played or displayed to the caller while the call is parked.

In another embodiment, the user may provide user input through the GUI 122 to automatically select how and which incoming calls are parked. For example, the GUI 122 may include fields for specifying phone numbers, caller identification information, calling type (i.e. long distance, out of country, etc), and other information to determine whether the call should be parked or sent directly to voicemail during a time in which the wireless device is placed in a silent mode.

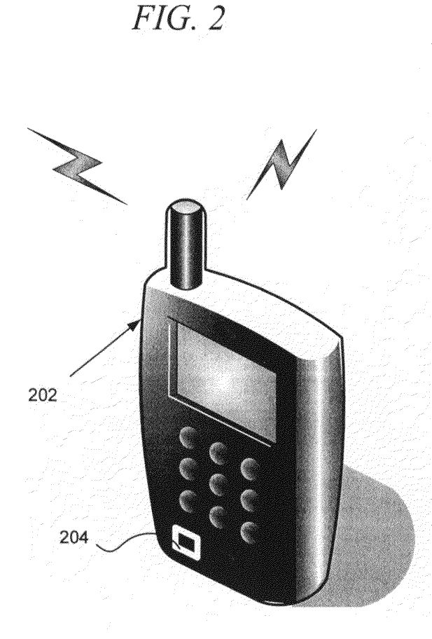

FIG. 2 is a wireless device in accordance with an illustrative embodiment. FIG. 2 includes a wireless telephone 202. The wireless telephone 202 may include a feature button 204. The feature button 204 may be an interface that allows the user to send a signal or command to internal call park logic, an internal processor, a mobile switching center, a voicemail system or other component of the communications system 100 of FIG. 1 for providing user input regarding a wireless call park feature.

The feature button 204 may be a dedicated button, combination or sequence of button selections, a touch screen, a microphone, a scroll wheel, or other input device that generates the command signal that activates the call park feature for the wireless telephone 202. The feature button 204 may also be a programmable element of a graphical user interface. The feature button 204 may be used to activate any of the methods, services, and expense categorization billing features herein described.

The wireless telephone 202 is a particular implementation of the wireless device 108 of FIG. 1. The wireless telephone 202 may operate through a wireless network. The wireless telephone 202, may include one or more accelerometers or electro sensitive sensors to receive user feedback in the form of a tactile response. In one embodiment, the user may tap the wireless telephone 202 to provide user feedback. For example, in order to indicate an incoming call is to be parked, the user may tap the phone twice. In another embodiment, a command to remove the caller from park may be generated by touching specific portions of the wireless telephone 202. For example, by touching and holding a corner of the wireless telephone 202, the wireless telephone 206 may place an incoming call in park and play a message specifying that the user is moving to a location where she is free to talk.

The wireless telephone 202 may also receive voice commands for controlling the call park feature. Additionally, the user may provide user input for parking purposes by touching or entering a number or number sequence on the wireless telephone 202.

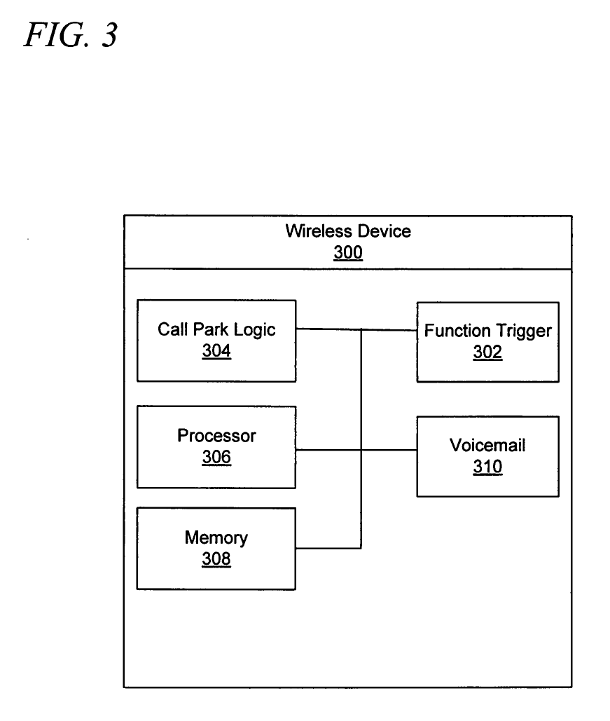

FIG. 3 is a block diagram of a wireless device in accordance with an illustrative embodiment. In one embodiment, the wireless device 300 is a particular implementation of the wireless devices 108, 110, 112, 114, and 116 of FIG. 1. The wireless device 300 may include various elements, components, or modules, including a function trigger 302, call park logic 304, a processor 306, and a memory 308. In another embodiment, the different components, programs, and functionality of the wireless device 300 may be integrated in a voicemail or announcement system, mobile switching center, wireless management system or a sub-component or module, or other wireless service provider control system.

The wireless device 300 may be a combination of hardware and software elements. The wireless device 300 may use various structures, formats, and hardware/software combinations included in currently available wireless devices. The example shown in FIG. 3 is shown for illustration purposes only, and not as a limitation of required elements. The wireless device 300 may be accessed by a user receiving an incoming call and park the incoming call. The wireless device 200 may process voice, text, video, picture and other media messages.

In one embodiment, the call park logic 304 may be hard-wired circuit elements, or programmable circuitry and logic for performing the call park feature. In another embodiment, the call park logic 304 may be integrated or stored within the memory 308 as a set of instructions. The set of instructions may be executed by the processor 306 to perform the outbound greeting process or activate a specialized feature. The processor 306 may be a computer processor, or other processing device used by the wireless device or voicemail system to process instructions, and otherwise perform data manipulation and processing, as required by the wireless device.

The memory 308 may be a hard drive or flash memory or other static or dynamic memory for storing data. However, the memory 308 may be any memory type or configuration suitable for storing and accessing electronic information and data.

The function trigger 302 may be configured to receive user input from the user in order to activate or deactivate the call park logic 304 and perform various functions as selected by the user. In another embodiment, the function trigger 302 may be integrated with the call park logic 304. The call park logic 304 places an incoming call in a temporary parked status when selected by the user. The call park logic 304 may control a display or graphical user interface of the wireless device 200 for indicating the status of the incoming call.

The call park logic 304 may play a specified message, music, or other media content to the caller accessible from the memory 308 when the call is parked or during the time period in which the incoming call is held. Alternatively, the call park logic 304 may be used to record and store customized voice, text, or video messages in the memory 308 for playback to one or more callers as selected by the user. The messages may specify a reason, details or circumstances that inform the caller why the call is on park or explain what is happening. As previously described, the call park logic 304 may be integrated on the wireless device 300 or may be part of a network server, such as a media player. The call park logic 304 may also store user preferences for controlling how and when calls are parked. The user may set the preferences using the wireless device 300 or may access the client 120, wireless management system 102, voicemail system 104, and wireless network 106 of FIG. 1 to establish preferences. For example, the user may specify phone numbers, time of day, blocks of time, or other information for specify which calls are parked or when they are parked.

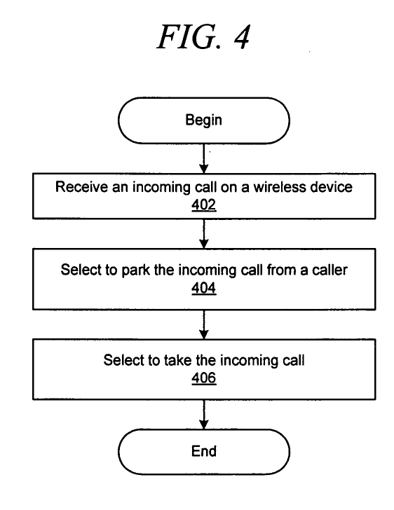

FIG. 4 is a flowchart of a process for receiving user input for parking a wireless call in accordance with an illustrative embodiment. The process of FIG. 4 may be implemented by a user with access to a wireless device. The wireless device may be any type of communications device capable of sending and receiving voice communications wirelessly.

The process begins with the user receiving an incoming call on a wireless device (step 402). During step 402, the wireless device may ring or otherwise alert the user that a call is incoming. A ring, as herein defined, may include an auditory sound, a flashing light, a light emitting display, a textual interface, a vibration, or other forms of alerts suitable for notifying a user that a call is being received by the wireless device. In one example, the user has the wireless device set to vibrate during a meeting in order to not disturb other participants in the meeting.

Next, the user selects to park the incoming call from a caller (step 404). The user input in step 404 may be received in any number of ways. In one embodiment, the user may press a dedicated button or enter a key code to park or place the incoming call on hold temporarily. In another embodiment, the user may tap the phone or make a selection using a touch screen display to park the incoming call. In yet another embodiment, the user may speak a voice command to park the incoming call as the wireless device rings. Once the incoming call is parked, the user may change locations or otherwise prepare to take the incoming call. In one example, the user may excuse himself from a meeting in order to answer the incoming call in privacy. In another example, the user may be in a theater, or other location, where it is socially unacceptable to take a phone call or begin an active conversation requiring the user to move to a location that is appropriate for voice conversation.

Next, the user selects to take the call (step 406). The selection of step 406 allows the user to remove the caller and corresponding incoming call from park, or a parked mode, in order to carry on a conversation. For example, after the user makes the selection of step 406, the incoming call is completed and the user and the caller are electronically linked for carrying on a normal voice conversation. The selection of step 406 may be received in any number of ways. In one example, the user wireless device is a cellular phone handset and, when opened or placed in a voice communication configuration, the user selects to take the call.

In other embodiments, the user may make other selections. For example, the user may determine that the situation is inappropriate to receive the incoming call and may transfer the parked call to voicemail. Alternatively, the user may transfer the parked call to another phone number. For example, the user may transfer the caller to the user's secretary in order to leave a message that may be later received by the user. The selection used may depend on the circumstances and whether the user is available to take the incoming call under the circumstances.

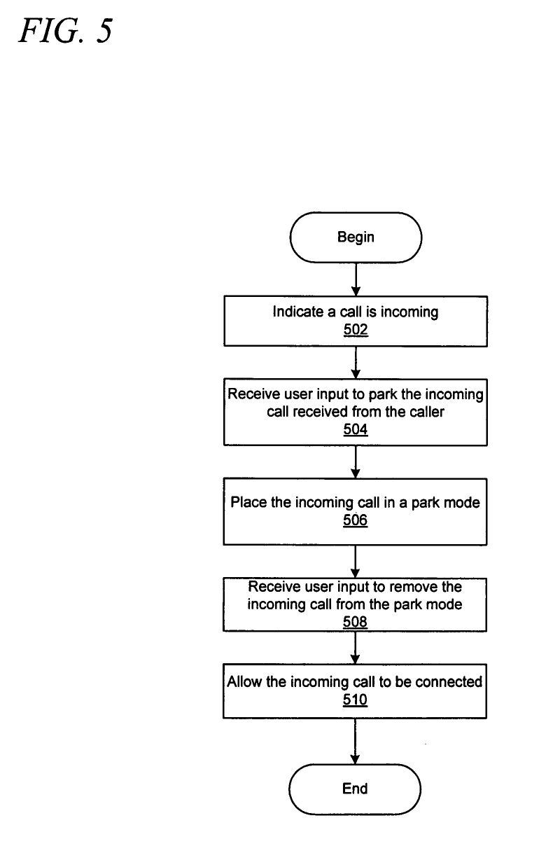

FIG. 5 is a flowchart of a process for parking a wireless call in accordance with an illustrative embodiment. The process of FIG. 5 may be implemented by a wireless device. In another embodiment, the process of FIG. 5 may be implemented by a wireless device in communication with a wireless management system or by voicemail system or media server through a wireless network. The process begins with the wireless device indicating a call is incoming (step 502). As previously described, the wireless device may provide the indication of step 502 using any type of ring, flashing light, vibration, stimulus, or alert.

Next, the wireless device receives user input to park the incoming call received from the caller (step 504). The user input of step 504 may be received as the incoming call is received or alternatively may have been pre-established before the incoming call occurred. For example, the user may have set a preference that any incoming calls be temporarily parked before being further processed or transferred.

The wireless device places the incoming call in a park mode (step 506). Parking the call, or a parked mode, as previously defined, may be a temporary holding process for the incoming call during which the incoming call is not connected to the receiving party. In one example, the call may be processed with the call being muted until the user selects to take the call. During step 506, the user may have established a message or music that is to be played to the user while the incoming call is temporarily parked. For example, the wireless device may play a message to the caller indicating that the user is attempting to answer the call if circumstances permit and to please hold on the line. The message may be played by the wireless device to preserve network resources or through a network device.

Next, the wireless device receives user input to remove the incoming call from the park mode (step 508). The user input of step 508 indicates that the user is now ready for the incoming call to be completed. In another embodiment, the wireless device may have a timer and once a specified time period has passed, the incoming call may be automatically removed from the park mode and connected, sent to voicemail, or otherwise processed, in accordance with user input and preferences. Next, the wireless device allows the incoming call to be connected (step 510) with the process terminating there. Once the incoming call is connected, the user and the caller may carry on a normal voice conversation.

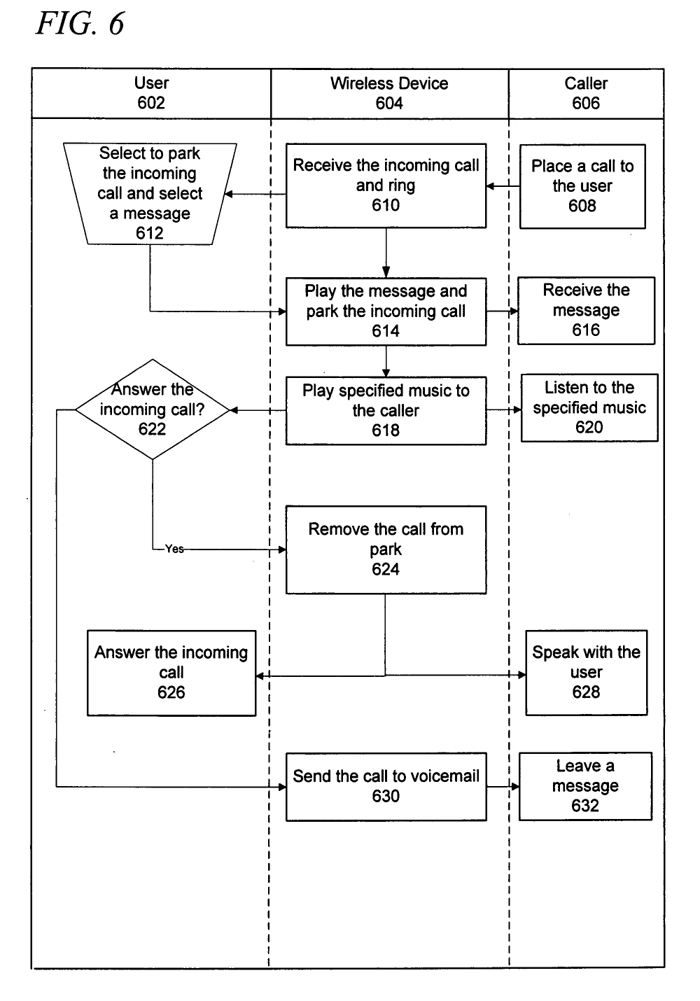

FIG. 6 is a flowchart of a process for parking a wireless call in accordance with an illustrative embodiment. The process of FIG. 6 may be implemented by a user 602, a wireless device 604, and a caller 606. The process of FIG. 6 begins with the caller 606 placing a call to the user 602 (step 608). Next, the wireless device receives the incoming call and rings (step 610).

The user 602 selects to park the incoming call and selects a message (step 612). The message may be any number of pre-programmed or default messages included in the programming and applications to the wireless device 604. Alternatively, the user 602 may have pre-recorded specific or customized messages that may be selected and played to the caller 606. It is important to note that the messages may be personally recorded by the user so that callers may recognize the voice of the user and more easily comprehend the call park feature if they have not experienced it before. The messages may also use text-to-speech conversion or professionally recorded messages that may be automatically stored on the wireless device 605.

Next, the wireless device 604 plays the message and parks the incoming call (step 614). At the same time, the caller 606 receives the message (step 616). In another embodiment, the wireless device 604 may automatically park incoming calls and play a message based on user preferences. For example, when the wireless device 604 is set to vibrate or a “silent mode”, the wireless device 604 may automatically park the incoming call temporarily and play a message stating, “I am in a meeting, let me see if I can get out for a moment”.

The wireless device plays specified music to the caller 606 (step 618). The user 602 may have previously selected a favorite song, podcast, news information, or other information, data, or broadcast to be played through the wireless device 604 to the caller 606 during (step 618). At the same time, the caller 606 listens to the specified music (step 620). Next, the user 602 determines whether to answer the incoming call (step 622). The determination of step 622 may be based on the circumstances of the user 602. For example, the user 602 may determine that she will be able to answer the incoming call once she moves to a different location.

If the user 602 determines to answer the incoming call in step 622, the wireless device 604 removes the call from park (step 624). Next, the user 602 answers the incoming call (step 626) and the caller 606 speaks with the user 602 (step 628).

If the user 602 determines not to answer the incoming call in step 622, the wireless device 604 sends the call to voicemail (step 630). Similarly, if the user 602 is unable to respond to the wireless device 604 within a specified time period, the wireless device 604 may play a message such as, “I am unable to get away at the moment, please leave a message”. At that point, the caller 606 may leave a message (step 632). In one example, the user 602 may have parked the incoming call from the caller 606 with the intention of answering the call only to determine that the circumstances do not permit her to answer the call. As a result, the incoming call may still be sent to voicemail in step 630.

In another embodiment, the user 602 may select to transfer the incoming call to a separate phone number or device or end the call without further action. For example, to ensure privacy, the user may transfer the call from the wireless device 604 to a plain old telephone service (POTS) telephone, VoIP phone, or other telephonic device. The message of step 632 may be recorded directly to the wireless device 604, or may be recorded to a voicemail system accessible by the wireless device 604. In either case, the user 602 may later retrieve the message recorded in step 632 by the caller 606.

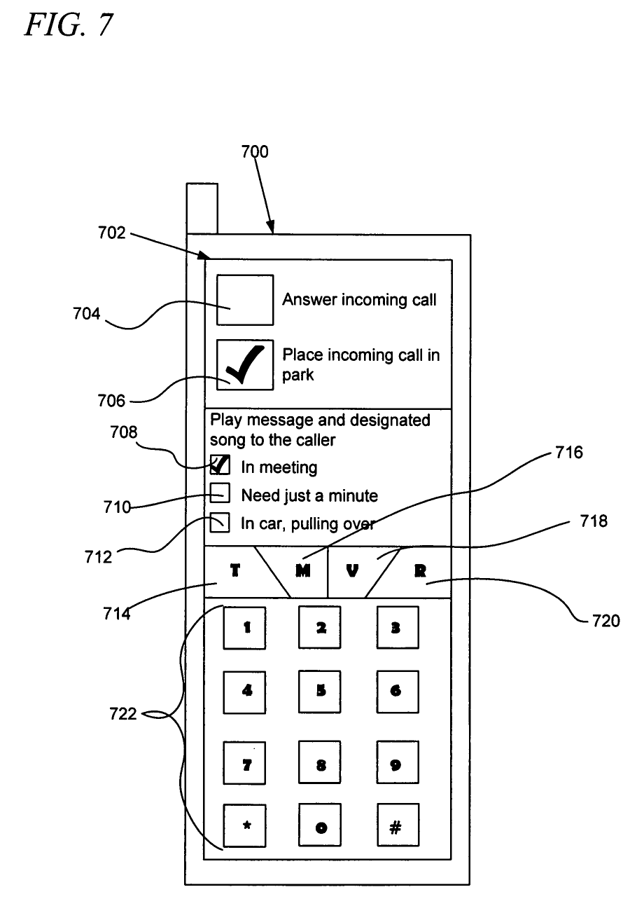

FIG. 7 is an interface of a wireless device in accordance with an illustrative embodiment. FIG. 7 includes a wireless device 700. The wireless device 700 is a particular implementation of the wireless devices 108, 110, 112, or 114, of FIG. 1. The wireless device 700 may include a graphical user interface 702. The graphical user interface 702 may include any number of buttons, indicators, displays, touch screens, or other elements suitable for receiving user input and displaying information to the user. In one embodiment, the graphical user interface 702 is a touch screen displaying all of the interactive elements, information, and text as shown. Each element shown on the graphical user interface 702 is referred to as a button and includes buttons 704, 706, 708, 710, 712, 714, 716, 718, 720, and buttons 722.

In one embodiment, the user may select button 704 to answer an incoming call. If, however, the user wants to place the incoming call in park the user selects button 706. The buttons 708, 710, and 712, may be displayed once the wireless device 700 begins to ring, or, alternatively, may be displayed on the graphical user interface 702 once button 706 is selected by the user. The buttons 708, 710, and 712, may be used to select a message to be played to the user once the incoming call is temporarily placed in park or temporarily held. In one embodiment, button 708 may specify that the user is in a meeting. In another embodiment, button 710 may simply specify that the user needs a minute in order to take the incoming call. For example, the user may already be on a phone call or may be in another person's office. Button 712 may be used to inform the caller that the user is driving and needs a second to pull over in order to safely carry on a voice conversation with the caller.

Buttons 714, 716, 718, and 720 may be used to provide additional user input or selections used by the wireless de vice 700 to implement the park feature. Button 714 may be used in conjunction with button 720 to transfer the incoming call to another phone number or selected device. For example, the user may select 716 to play a song to the caller while the call is in park. In another example, the user may select button 718 to automatically transfer the caller to voicemail. Button 720 may be used to release the call once the user is available.

Button 722 may be used for the normal dialing, messaging, and command inputs for the wireless device 700. A combination of button selections, codes, or specified commands may be entered using buttons 722 to control wireless call parking as herein described. The elements of the graphical user interface 702 may include displays, touch screens, or hard-wired selection elements that allow the user to provide user input and selections while operating the park feature of the wireless device 700.

The illustrative embodiments allow a user to easily and effectively park an incoming call. The incoming call may be parked so that the user may subsequently answer the call, or make himself or herself available to answer the call. Alternatively, once parked, the call may be transferred to voicemail, or to another phone number, or otherwise processed, as selected by the user. The call park feature provides users more opportunities to answer incoming calls without disruption to those with whom they associate or to those in their proximity. As a result, wireless usage is encouraged while minimizing the negative social effects of a ringing wireless device or a voice conversation that is carried on in an inappropriate setting.

The previous detailed description is of a small number of embodiments for implementing the invention and is not intended to be limiting in scope. The following claims set forth a number of the embodiments of the invention disclosed with greater particularity.

What is claimed:

1. A method for parking an incoming call, said method comprising:
receiving user input on a wireless device to park the incoming call;
parking the incoming call;
playing an announcement to a caller; and
connecting the incoming call to facilitate a communication between a user and the caller in response to receiving user input to release the incoming call.

2. The method according to claim 1, further comprising:
displaying call information to the user to determine whether to park the incoming call.

3. The method according to claim 1, wherein the announcement indicates that the user intends to answer the incoming call.

4. The method according to claim 3, wherein the playing comprises:
playing the announcement to the user based on a user selection.

5. The method according to claim 4, wherein the announcement specifies why the incoming call is temporarily parked.

6. The method according to claim 1, the holding further comprises:
playing music to the caller based on a user selection.

7. The method according to claim 1, wherein the user input is tactile input into the wireless device.

8. The method according to claim 1, further comprising:
receiving the incoming call, wherein the user provides the user input to temporarily park the incoming call while the wireless device is ringing.

9. The method according to claim 1, wherein the receiving, holding, and connecting is performed by a voicemail system.

10. The method according to claim 1, wherein the connecting comprises:
transferring the incoming call to voicemail of the user.

11. The method according to claim 1, wherein the connecting comprises:
transferring the incoming call to another telephonic device.

12. The method according to claim 1, further comprising:
automatically holding the incoming call, wherein the user input was received prior to receiving the incoming call.

13. A wireless device for call parking, said device comprising:
call park logic configured to receive user input to park an incoming call, park the incoming call, and connect the incoming call to facilitate a communication between a user and a caller in response to receiving user input to release the incoming call; and
a memory in communication with the call park logic configured to play a stored message to the caller when the incoming call is parked based on the user input.

14. The system according to claim 13, wherein the user selects a plurality of messages to store in the memory, the message is selected by the user from the plurality of messages.

15. The system according to claim 13, wherein the call park logic includes a timer for measuring a time period, wherein the incoming call is automatically processed at the end of the time period.

16. The system according to claim 13, further comprising:
a voicemail system in communication with the wireless device configured to process the incoming call based on a selection from the user.

17. The system according to claim 13, wherein the user may set a preference for the call park logic to automatically park all incoming calls.

18. A wireless call park system comprising:
a processor for executing a set of instructions; and
a memory for storing the set of instructions, wherein the set of instructions are configured to receive user input on a wireless device to park the incoming call, park the incoming call, and connect the incoming call to facilitate a communication between a user and a caller in response to receiving user input to release the incoming call.

19. The wireless call park system according to claim 18, wherein the set of instructions are configured to record one or more announcements from the user that may be played to the caller as selected by the user.

20. The wireless call park system according to claim 18, wherein the set of instructions are configured to record a message from the caller in response to the user input indicating not to connect the user and the caller.

21. The wireless call park system according to claim 18, wherein the set of instructions are configured to transfer the incoming call to a telephonic device based on the user input.

22. The wireless call park system according to claim 18, wherein the one or more announcements specifies why the incoming call is temporarily parked.
